(19) United States
(12) Patent Application Publication
(10) Pub. No.: US 2026/0080303 A1
(43) Pub. Date: Mar. 19, 2026

(54) SYSTEM AND METHOD FOR REFINING LINGUAL MATCHING TUNING

(71) Applicant: INTUIT INC., Mountain View, CA (US)

(72) Inventors: Hadas BAUMER, Tel Aviv (IL); Omer WOSNER, Tel Aviv (IL); Lior TABORI, Tel Aviv (IL)

(73) Assignee: INTUIT INC., Mountain View, CA (US)

(21) Appl. No.: 18/889,236

(22) Filed: Sep. 18, 2024

(51) Int. Cl. G06N 20/00

(52) U.S. Cl. CPC G06N 20/00

(57) ABSTRACT

A system and method are provided for refining lingual matching tuning.

### BACKGROUND OF THE DISCLOSURE

When finetuning classification models, it is generally desirable to increase the distance between the probability distributions of “true” and “false classes, even up to the point where they do not intersect at all. This can enable, or approach, maximum differentiation. It is therefore desirable to match similar records that are composed of text via finetuning a pre-trained language model, such that similar records will receive similar vector embeddings, and different ones will receive vector embeddings which are far apart. However, datasets that are used to train such models are frequently suboptimal. For example, datasets frequently include “easy” examples of records. In other words, they include records that already have very similar or very different representations in the underlying embedding model. Such records do not add value during subsequent finetuning processes, which is undesirable.

### BRIEF DESCRIPTION OF THE FIGURES

FIG. 1 is a block diagram of an example system for refining lingual matching tuning according to example embodiments of the present disclosure.

FIG. 2 is a flowchart of an example process for refining lingual matching tuning according to example embodiments of the present disclosure.

FIG. 3 is another flowchart of an example flow for refining lingual matching tuning according to example embodiments of the present disclosure.

FIG. 4 is another flowchart of an example flow for refining lingual matching tuning according to example embodiments of the present disclosure.

FIGS. 5A and 5B are example true/false distributions according to example embodiments of the present disclosure.

FIG. 6 is server device that can be used within the system of FIG. 1 according to an embodiment of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

One potential technique to deal with the above-mentioned issue where records in a training dataset are too similar such that they are not valuable for finetuning embedding models, “false” example data records with known matches paired with any other record in the dataset could be added to the dataset. However, randomly selecting any other record frequently creates pairs with very low similarity. With such pairs, there is little to be gained during the finetuning process because the original model itself can determine that they are different.

Embodiments of the present disclosure overcome these and other technical issues by providing a novel system and method for refining lingual matching tuning. The disclosed system and method can iteratively process a dataset to increase its value for training and/or finetuning a classification model. The disclosed system and method can iteratively reduce the frequency of highly similar data pairs (i.e., “positive match pairs”) in a training dataset while also reducing the frequency of highly dissimilar data pairs (i.e., “false sample pairs”). Such reduction of the training dataset increases its “value” during subsequent training processes, thereby increasing the effectiveness at which models can be trained, their ultimate accuracy, and the overall robustness of the classifier. The disclosed system and method can, at each iteration, evaluate various model metrics to identify when increases in performance are no longer realized, thereby allowing for a determination of a final version of the model. In particular, the disclosed system can calculate a performance metric for a model, fine-tune the model, calculate a performance metric for the fine-tuned model, and compare the metrics. The system can perform this iteratively until improvements are no longer being realized. However, to the extent an increase in performance is identified from one version of a model to a subsequent finetuned version of the model, the method can continue with another finetuning stage.

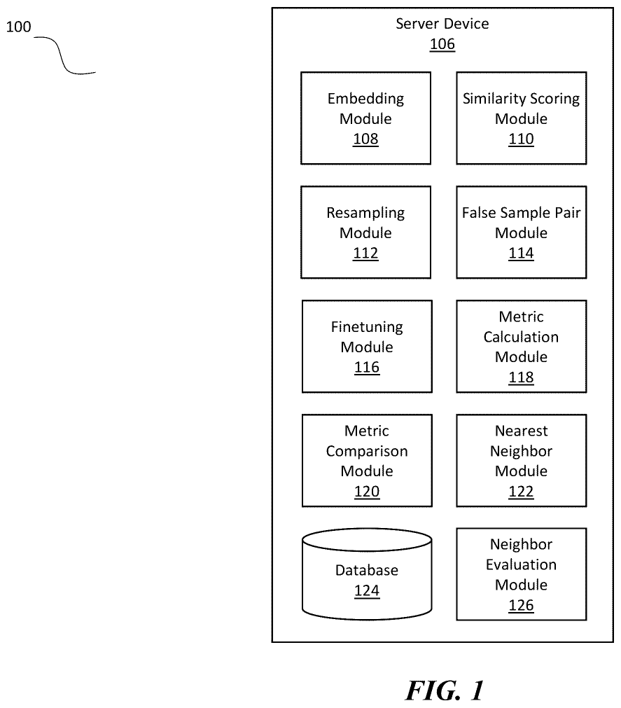

FIG. 1 is a block diagram of an example system 100 for refining lingual matching tuning according to example embodiments of the present disclosure. The system 100 can include a server 106 that can perform finetuning processes for various classification models.

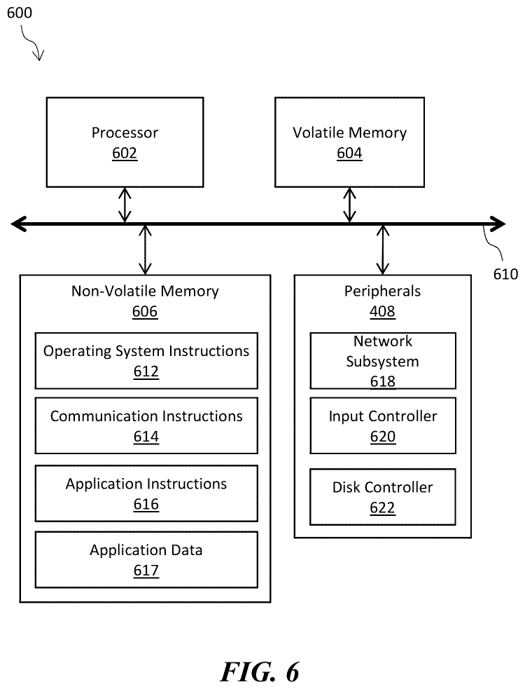

The server 106 may include any combination of one or more of web servers, mainframe computers, general-purpose computers, personal computers, or other types of computing devices. The server 106 may represent distributed servers that are remotely located and communicate over a communications network, or over a dedicated network such as a local area network (LAN). The server 106 may also include one or more back-end servers for carrying out one or more aspects of the present disclosure. In some embodiments, the server 106 may be the same as or similar to server 600 described below in the context of FIG. 6.

As shown in FIG. 1, the server 106 includes an embedding module 108, a similarity scoring module 110, a resampling module 112, a false sample pair module 114, a finetuning module 116, a metric calculation module 118, a metric comparison module 120, a nearest neighbor module 122, and a neighbor evaluation module 126. The server 106 can also include a database 124 that is configured to store and maintain various records. For example, the database 124 can store both training and testing datasets that can be used for the disclosed finetuning processes.

In some embodiments, the embedding module 108 is configured to create initial vector representations (i.e., an “embedding”) of data records contained in the database 124. For example, the embedding module 108 can identify a training dataset and embed it to create an embedded training dataset. In addition, the embedding module 108 can embed testing data to create an embedded testing dataset. The embedding module 108 is configured to apply various vectorization techniques to embed data, such as text, to vector form within a continuous vector space. In some embodiments, a word2vec model may be used to embed text to the vector space. The word2vec model may use a continuous bag-of-words approach (CBOW), a skip-gram approach, or other similar approaches. In some embodiments, embedding module 108 can employ other embedding frameworks such as GloVe (Global Vector) or FastText. In some embodiments, embedding module 108 can be tunable. In some embodiments, embedding module 108 may include an encoder and/or a neural network architecture to perform the embedding processes.

In some embodiments, the similarity scoring module 110 is configured to evaluate the similarity between vectors, such as various embedded data records of a training dataset generated by the embedding module 108. In some embodiments, the similarity scoring module 110 is configured to apply various different distance metrics, such as cosine similarity, Euclidean distance, Manhattan distance, and a weighted distance. In some embodiments, cosine similarity can measure the cosine of the angle between the two vectors. In some embodiments, cosine similarity can be useful when the magnitude of the vectors is not as relevant as the orientation (i.e., the direction or pattern of the data). Cosine similarity is often used in text analysis where the presence or absence of specific terms (and their relative frequencies) is more desirable than the absolute term counts. In some embodiments, the Euclidean distance can represent the “straight-line” distance between two points in multidimensional space. The Euclidean distance can measure the absolute difference between the two vectors and can be effective when the scale of the components and the magnitude of the vectors are desirable for the evaluation. In some embodiments, the Manhattan distance can calculate the sum of the absolute differences of the Cartesian coordinates of the vectors. Also known as the “taxicab” or “city block” distance, this metric can be used when it is desirable to emphasize differences in individual dimensions or features of the embeddings. In some embodiments, a weighted distance can be a variation of the above metrics where individual dimensions are weighted differently, reflecting their importance in the domain-specific context. This approach can enable the tailoring of distance calculations to emphasize more significant features while downplaying less desirable ones. In some embodiments, the similarity scoring module 110 can be configured to select particular distance metrics to employ based on the domain's characteristics and the specific nature of the content being evaluated.

In some embodiments, the resampling module 112 is configured to resample positive match pairs from within a training dataset. In some embodiments, the resampling module 112 can execute such resampling techniques to reduce the frequency at which data pairs within the training dataset are highly similar. For example, the resampling module 112 can filter data pairs out of the training dataset when such data pairs have a similarity score above a predefined threshold.

In some embodiments, the false sample pair module 114 is configured to generate a plurality of false sample pairs. For example, the false sample pair module 114 can generate the plurality of false sample pairs based on a predefined similarity distribution, such as a Gaussian distribution. In some embodiments, the false sample pair module 114 is configured to evaluate the similarity scores generated by the similarity scoring module 110 to generate the plurality of false sample pairs according to the desired distribution.

In some embodiments, the finetuning module 116 is configured to compile a training dataset comprising the positive match pairs created by the resampling module 112 and the false sample pairs generated by the false sample pair module 114. In addition, the finetuning module 116 can be configured to finetune the original model used by the embedding module 108 to embed the data records to create a finetuned model.

In some embodiments, the metric calculation module 118 is configured to calculate one or more metrics that can be used to evaluate the performance of models and finetuned models. In some embodiments, the metric calculation module 118 can calculate a precision value, a recall value, area under the curve (AUC), an F1 score, log loss, etc. For example, during an iterative finetuning process, the metric calculation module 118 can calculate a performance metric for both a first model and a second model, which is a finetuned version of the first model.

In some embodiments, the metric comparison module 120 is configured to compare metrics that have been calculated for separate models to identify if an improvement in performance has occurred. For example, during an iterative finetuning process, the metric comparison module 120 can compare a first metric for a first model and a second metric for a finetuned version of the first model to determine if there has been an improvement. In some embodiments, identifying an improvement from the first metric to the second metric can include determining that the second metric is greater than or equal to the first metric by a predetermined amount.

In some embodiments, the nearest neighbor module 122 is configured to execute a nearest neighbor search using an external dataset. For example, in response to the metric comparison module 120 determining that the second metric of the finetuned model is not greater than or equal to the first metric of the first model by the predetermined amount, the nearest neighbor module 122 can execute the nearest neighbor search to identify a nearest neighbor for a positive match pair in the testing dataset.

In some embodiments, the neighbor evaluation module 126 is configured to evaluate a frequency at which the nearest neighbor for a positive match pair comprises a correct match. For example, the neighbor evaluation module 126 can replace a data record in a positive match pair with its nearest neighbor and determine if that new pair is still a correct match. Based on performing this analysis for the testing dataset, the neighbor evaluation module 126 can determine a frequency at which the nearest neighbors remain matches. For example, the neighbor evaluation module 126 can execute such an analysis for both a first model and a finetuned second model.

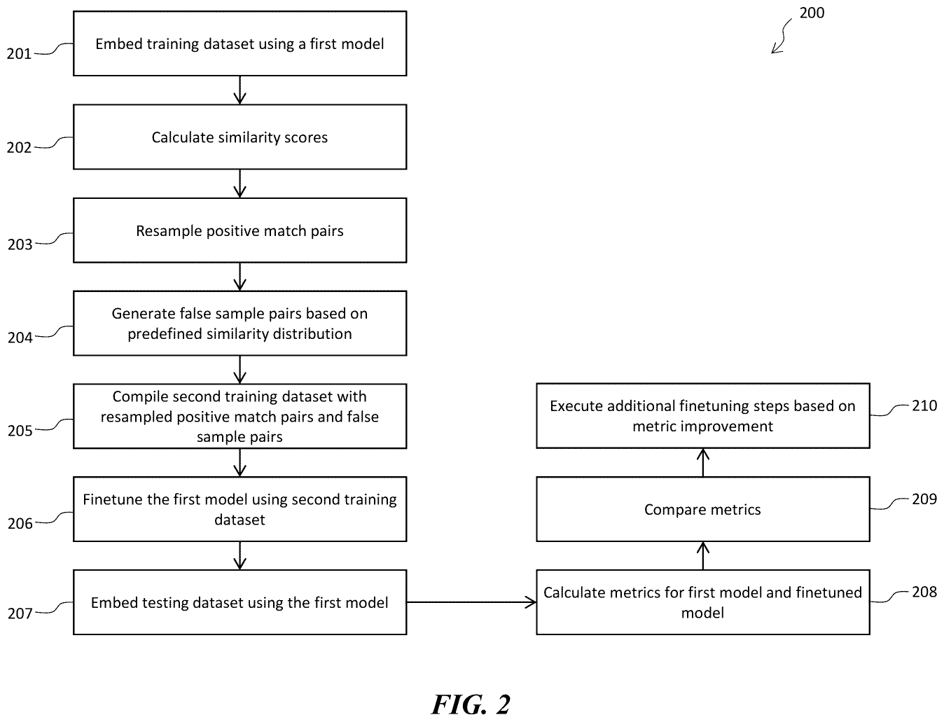

FIG. 2 is a flowchart of an example process 200 for refining lingual matching tuning according to example embodiments of the present disclosure. In some embodiments, the process 200 can be performed by the server 106 and its various modules. At block 201, the embedding module 108 embeds a training dataset to a vector space using a first model to generate an embedded training dataset. In some embodiments, the embedding module 108 can apply various vectorization techniques to embed the training dataset to a vector form within a vector space. As discussed above, the embedding module 108 can utilize various vectorization models such as word2vec, GloVe, FastText, etc.

At block 202, the similarity scoring module 110 calculates a plurality of similarity scores using the records within the embedded training dataset. In some embodiments, the similarity scoring module 110 can calculate similarity scores for various permutations of pairs between records within the training dataset. In some embodiments, the similarity scoring module 110 can also calculate similarity scores for additional possible match candidate embeddings, which can include embedded records from outside the training dataset itself but part of the broader general dataset in which the training dataset was taken from. As discussed above in relation to FIG. 1, the similarity scoring module 110 can use one or more of various types of similarity scoring techniques, such as cosine similarity, Euclidean distance, Manhattan distance, or a weighted distance.

At block 203, the resampling module 112 resamples the positive match pairs from within the embedded training dataset based on the plurality of similarity scores. For example, in some embodiments, the resampling module 112 can filter data pairs out of the embedded training dataset when such data pairs have a similarity score above a predefined threshold. At block 204, the false sample pair module 114 generates a plurality of false sample pairs based on a predefined similarity distribution. For example, the false sample pair module 114 can select negative samples (i.e., false sample pairs) from within the embedded match candidate embeddings and the embeddings from the embedded training dataset. In some embodiments, the similarity distribution can be a Gaussian distribution.

At block 205, the finetuning module 116 compiles a second training dataset that includes the resampled positive match pairs and the false sampled match pairs. At block 206, the finetuning module 116 finetunes the first model from the embedding module 108 using the second training dataset to generate a finetuned model. At block 207, the embedding module 108 embeds the testing dataset using the first model. At block 208, the metric calculation module 118 calculates one or more metrics for the first model and the finetuned model. In some embodiments, calculating the one or more metrics can include calculating a precision value, a recall value, area under the curve (AUC), an F1 score, log loss, etc.

At block 209, the metric comparison module 120 compares the first metric for the first model and the second metric for the finetuned model. In some embodiments, the metric comparison module 120 can determine if an improvement in performance has occurred from the first model to the finetuned model. In some embodiments, identifying an improvement from the first metric to the second metric can include determining that the second metric is greater than or equal to the first metric by a predetermined amount. At block 210, the finetuning module 116 executes additional finetuning steps based on the identified metric improvement. For example, the process 200 can be an iterative process where, blocks 201-209 make up an finetuning iteration or finetuning stage. If an improvement is identified between the first model and the finetuned model, the process 200 can be repeated. However, when the process 200 is repeated, the finetuned model from the first iteration can become the first model and a second finetuned model is ultimately created. In this manner, finetuning iterations can be used to subsequently increase the performance of the underlying embedding model.

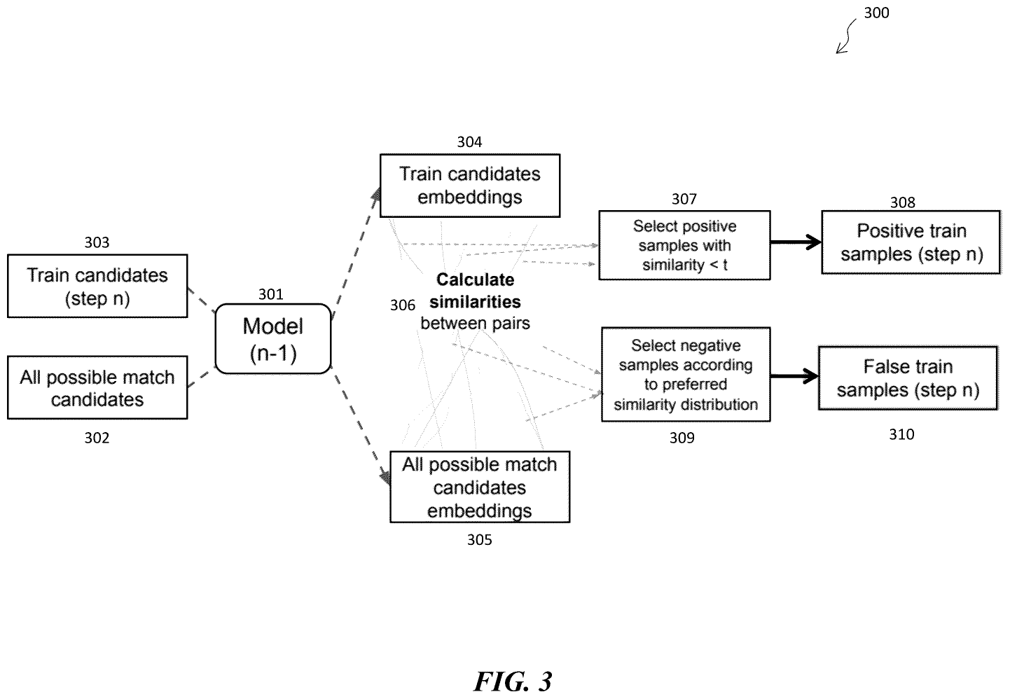

FIG. 3 is another flowchart of an example flow 300 for refining lingual matching tuning according to example embodiments of the present disclosure. In some embodiments, the process 300 can also be performed by the server 106 and its various modules. For example, in some embodiments, the process 300 can be a visualization of the flow of blocks 201-205 of FIG. 2. The flow 300 can include a model 301, which can be the first model as described in process 200 and can be contained within the embedding module 108. The model 301 can embed candidates for training 303 to generate train candidate embeddings 304 (i.e., the embedded training dataset). In addition, the model 301 can embed other possible match candidates 302 to generate all possible match candidate embeddings 305. At 306, the similarity scoring module 110 calculates similarities between a plurality of pairs of embeddings, such as within only the train candidate embeddings 304. In addition, the similarity scoring module 110 can calculate similarity scores within all possible match candidate embeddings 305. At 307, the resampling module 112 can select positive match pairs based on their similarity scores. For example, the resampling module 112 can select pairs with a similarity score below a predefined threshold and filter out the pairs with a similarity score above the predefined threshold. These can be compiled by the finetuning module 116 as the positive train samples 308. At 309, the false sample pair module 114 can select negative samples according to a predefined similarity distribution, which can then form the plurality of false train samples 310. In some embodiments, both the positive train samples 308 and the false train samples 310 can form the second training dataset as discussed in relation to FIG. 2.

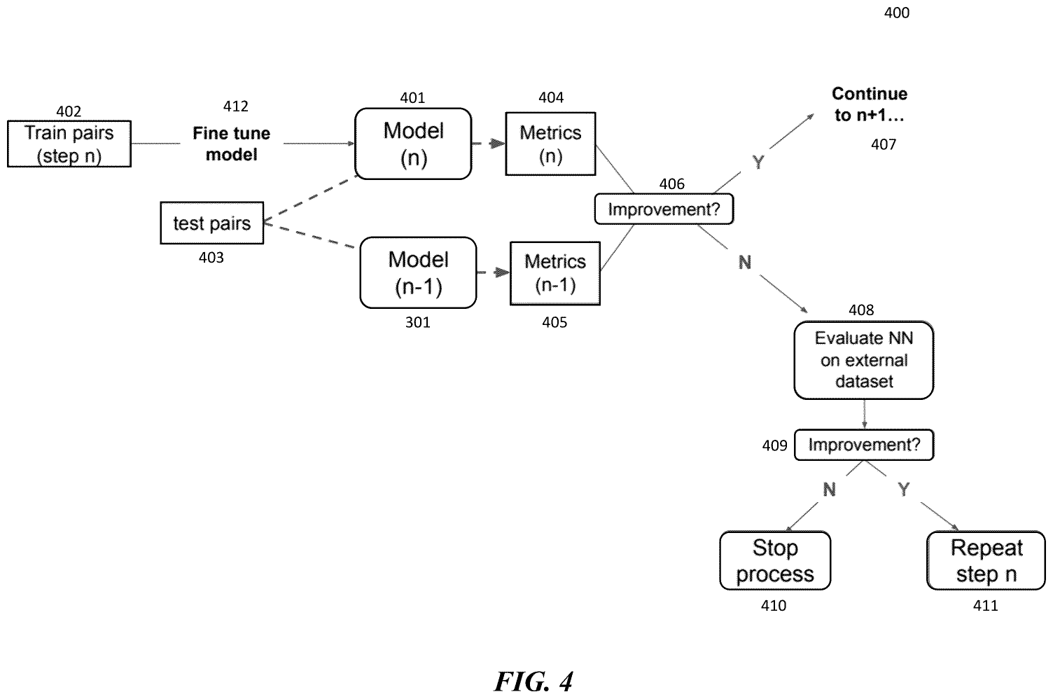

FIG. 4 is another flowchart of an example flow 400 for refining lingual matching tuning according to example embodiments of the present disclosure. At 412, the model 301 is finetuned via the finetuning module 116 with an embedded training dataset 402, which can include the positive train samples 308 and the false train samples 310 from FIG. 3. The finetuning at 412 can create a finetuned model 401. At 404, the metric calculation module 118 can calculate one or more metrics for the finetuned model 401. In some embodiments, the metrics can be calculated using embedded test pair data 403. In addition, at 405, the metric calculation module 118 can calculate one or more metrics for the first model 301. At 406, the metric comparison module 120 compares the metrics from 404 and 405 to determine if an improvement has occurred. If, as discussed above in relation to FIG. 2, an improvement has been identified by the metric comparison module 120, processing proceeds to 407 where additional finetuning processes are executed to further finetune the model with additional iterations.

If, at 406, an improvement has not been identified, processing proceeds to 408, where the nearest neighbor module 122 can execute a nearest neighbor search on an external dataset and the neighbor evaluation module 126 can evaluate the results of the search. For example, the neighbor evaluation module 126 can evaluate a frequency at which the nearest neighbor for a positive match pair comprises a correct match. In some embodiments, the neighbor evaluation module 126 can replace a data record in a positive match pair with its nearest neighbor and determine if that new pair is still a correct match. Based on performing this analysis for the embedded testing data set, the neighbor evaluation module 126 can determine a frequency at which the nearest neighbors remain matches. The neighbor evaluation module 126 can determine such a frequency for both the first model 301 and the finetuned model 401. At 409, the neighbor evaluation module 126 can determine if an improvement in frequency was realized from the first model 401 to the finetuned model 401. In some embodiments, determining if an improvement in frequency was realized from the first model 401 to the finetuned model 401 can include determining that the second frequency is greater than or equal to the first frequency by a predetermined frequency amount. If no improvement is identified at 409, the flow 400 proceeds to 410 and stops, and the finetuned model 401 can be selected as a final model.

If there is improvement identified at 409, then the flow 400 can repeat but with one or more variations. For example, during a repeated flow 400, the false sample pair module 114 can generate the plurality of false matching pairs based on a second predefined similarity distribution different than the originally used predefined similarity distribution. Alternatively or additionally, a new training dataset can be used from the beginning. For example, the embedding module 108 can generate an embedded training dataset using different training data. In another embodiment, different parameters can be used, such as different learning rates, number of epochs, batch sizes, optimizers, warmup proportions, regularization, drop-out, etc.

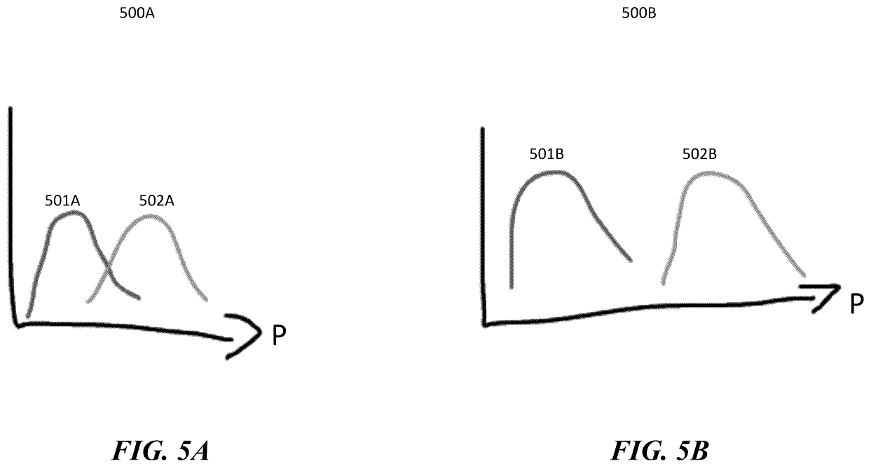

FIGS. 5A and 5B are example true/false distributions according to example embodiments of the present disclosure. In particular, FIG. 5A shows a graph 500A that plots a false sample pair distribution 501A and a positive match pair distribution 502A. In FIG. 5A, there is overlap between the distributions 501A and 502A, which is undesirable. In some embodiments, the iterative finetuning techniques described herein can lead to more desirable distributions such as the distributions shown in FIG. 5B. In FIG. 5B, a graph 500B plots a false sample pair distribution 501B and a positive match pair distribution 502B. In FIG. 5B, there is reduced overlap between the distributions 501B and 502B, which generally leads to a more robust model and better results overall.

FIG. 6 is a diagram of an example server device 600 that can be used within system 100 of FIG. 1. Server device 600 can implement various features and processes as described herein. Server device 600 can be implemented on any electronic device that runs software applications derived from complied instructions, including without limitation personal computers, servers, smart phones, media players, electronic tablets, game consoles, email devices, etc. In some implementations, server device 600 can include one or more processors 602, volatile memory 604, non-volatile memory 606, and one or more peripherals 608. These components can be interconnected by one or more computer buses 610.

Processor(s) 602 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 610 can be any known internal or external bus technology, including but not limited to ISA, EISA, PCI, PCI Express, USB, Serial ATA, or FireWire. Volatile memory 604 can include, for example, SDRAM. Processor 602 can receive instructions and data from a read-only memory or a random access memory or both. Essential elements of a computer can include a processor for executing instructions and one or more memories for storing instructions and data.

Non-volatile memory 606 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 606 can store various computer instructions including operating system instructions 612, communication instructions 614, application instructions 616, and application data 617. Operating system instructions 612 can include instructions for implementing an operating system (e.g., Mac OS®, Windows®, or Linux). The operating system can be multi-user, multiprocessing, multitasking, multithreading, real-time, and the like. Communication instructions 614 can include network communications instructions, for example, software for implementing communication protocols, such as TCP/IP, HTTP, Ethernet, telephony, etc. Application instructions 616 can include instructions for various applications. Application data 617 can include data corresponding to the applications.

Peripherals 608 can be included within server device 600 or operatively coupled to communicate with server device 600. Peripherals 608 can include, for example, network subsystem 618, input controller 620, and disk controller 622. Network subsystem 618 can include, for example, an Ethernet of WiFi adapter. Input controller 620 can be any known input device technology, including but not limited to a keyboard (including a virtual keyboard), mouse, track ball, and touch-sensitive pad or display. Disk controller 622 can include one or more mass storage devices for storing data files; such devices include magnetic disks, such as internal hard disks and removable disks; magneto-optical disks; and optical disks.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computing system comprising:
a processor; and
a non-transitory computer-readable storage device storing computer-executable instructions, the instructions operable to cause the processor to perform operations comprising:
embedding, via a first model, a training dataset comprising a plurality of data pairs to a vector space to generate an embedded training dataset;
calculating a plurality of similarity scores, the plurality of similarity scores comprising a similarity score for each of the plurality of data pairs;
resampling one or more positive match pairs based on the plurality of similarity scores;
generating a plurality of false sample pairs based on a predefined similarity distribution;
compiling a second training dataset comprising the one or more resampled positive match pairs and the plurality of false sample pairs; and
finetuning the first model using the second training dataset to improve an embedding capability of the first model.

2. The computing system of claim 1, wherein resampling the one or more positive match pairs comprises filtering out data pairs of the plurality of data pairs with a similarity score above a predefined threshold.

3. The computing system of claim 1, wherein generating the plurality of false sample pairs based on the predefined similarity distribution comprises generating the plurality of false sample pairs based on a Gaussian distribution.

4. The computing system of claim 1, wherein the operations comprise:
embedding, via the first model, a testing dataset to the vector space to generate an embedded testing dataset;
calculating a first metric for the first model and a second metric for the finetuned model;
comparing the first metric and the second metric; and
in response to identifying an improvement from the first metric to the second metric, executing a second finetuning process.

5. The computing system of claim 4, wherein identifying the improvement from the first metric to the second metric comprises determining that the second metric is greater than or equal to the first metric by a predetermined amount.

6. The computing system of claim 5, wherein the operations comprise, in response to determining that the second metric is not greater than or equal to the first metric by the predetermined amount:
executing a nearest neighbor search on an external dataset;
evaluating a first frequency at which a nearest neighbor comprises a correct match for the first model and a second frequency at which a nearest neighbor comprises a correct match for the finetuned model; and
in response to determining that the second frequency is greater than or equal to the first frequency by a predetermined frequency amount:
generating the plurality of false sample pairs based on a second predefined similarity distribution; or
embedding, via the first model, a second training dataset comprising a second plurality of data pairs to the vector space to generate a second embedded training dataset.

7. The computing system of claim 6, wherein the operations comprise, in response to determining that the second frequency is not greater than or equal to the first frequency by the predetermined frequency amount, selecting the finetuned model as a final model.

8. The computing system of claim 4, wherein executing the second finetuning process comprises:
embedding, via the finetuned model, the training dataset to the vector space to generate a second embedded training dataset;
calculating a second plurality of similarity scores, the second plurality of similarity scores comprising a similarity score for each of the plurality of data pairs;
resampling one or more second positive match pairs based on the second plurality of similarity scores;
generating a second plurality of false sample pairs based on a second predefined similarity distribution;
compiling a third training dataset comprising the one or more resampled second positive match pairs and the second plurality of false sample pairs;
finetuning the finetuned model using the third training dataset to create a second finetuned model;
embedding, via the finetuned model, the testing dataset to the vector space to generate a second embedded testing dataset;
calculating a third metric for the finetuned model and a fourth metric for the second finetuned model;
comparing the third metric and the fourth metric; and
in response to identifying an improvement from the third metric to the fourth metric, executing a third finetuning process.

9. The computing system of claim 8, wherein generating the second plurality of false sample pairs based on a second predefined similarity distribution comprises generating the second plurality of false sample pairs based on a shifted predefined similarity distribution.

10. The computing system of claim 8, wherein the operations comprise iteratively executing finetuning processes until a metric plateau is identified.

11. A computer-implemented method, performed by at least one processor, comprising:
embedding, via a first model, a training dataset comprising a plurality of data pairs to a vector space to generate an embedded training dataset;
calculating a plurality of similarity scores, the plurality of similarity scores comprising a similarity score for each of the plurality of data pairs;
resampling one or more positive match pairs based on the plurality of similarity scores;
generating a plurality of false sample pairs based on a predefined similarity distribution;
compiling a second training dataset comprising the one or more resampled positive match pairs and the plurality of false sample pairs; and
finetuning the first model using the second training dataset to improve an embedding capability of the first model.

12. The computer-implemented method of claim 11, wherein resampling the one or more positive match pairs comprises filtering out data pairs of the plurality of data pairs with a similarity score above a predefined threshold.

13. The computer-implemented method of claim 11, wherein generating the plurality of false sample pairs based on the predefined similarity distribution comprises generating the plurality of false sample pairs based on a Gaussian distribution.

14. The computer-implemented method of claim 11 comprising:
embedding, via the first model, a testing dataset to the vector space to generate an embedded testing dataset;
calculating a first metric for the first model and a second metric for the finetuned model;
comparing the first metric and the second metric; and
in response to identifying an improvement from the first metric to the second metric, executing a second finetuning process.

15. The computer-implemented method of claim 14, wherein identifying the improvement from the first metric to the second metric comprises determining that the second metric is greater than or equal to the first metric by a predetermined amount.

16. The computer-implemented method of claim 15, comprising, in response to determining that the second metric is not greater than or equal to the first metric by the predetermined amount:
executing a nearest neighbor search on an external dataset;
evaluating a first frequency at which a nearest neighbor comprises a correct match for the first model and a second frequency at which a nearest neighbor comprises a correct match for the finetuned model; and
in response to determining that the second frequency is greater than or equal to the first frequency by a predetermined frequency amount:
generating the plurality of false sample pairs based on a second predefined similarity distribution; or
embedding, via the first model, a second training dataset comprising a second plurality of data pairs to the vector space to generate a second embedded training dataset.

17. The computer-implemented method of claim 16, comprising, in response to determining that the second frequency is not greater than or equal to the first frequency by the predetermined frequency amount, selecting the finetuned model as a final model.

18. The computer-implemented method of claim 14, wherein executing the second finetuning process comprises:
embedding, via the finetuned model, the training dataset to the vector space to generate a second embedded training dataset;
calculating a second plurality of similarity scores, the second plurality of similarity scores comprising a similarity score for each of the plurality of data pairs;
resampling one or more second positive match pairs based on the second plurality of similarity scores;
generating a second plurality of false sample pairs based on a second predefined similarity distribution;
compiling a third training dataset comprising the one or more resampled second positive match pairs and the second plurality of false sample pairs;
finetuning the finetuned model using the third training dataset to create a second finetuned model;
embedding, via the finetuned model, the testing dataset to the vector space to generate a second embedded testing dataset;
calculating a third metric for the finetuned model and a fourth metric for the second finetuned model;
comparing the third metric and the fourth metric; and
in response to identifying an improvement from the third metric to the fourth metric, executing a third finetuning process.

19. The computer-implemented method of claim 18, wherein generating the second plurality of false sample pairs based on a second predefined similarity distribution comprises generating the second plurality of false sample pairs based on a shifted predefined similarity distribution.

20. The computer-implemented method of claim 18, comprising iteratively executing finetuning processes until a metric plateau is identified.
